(19) United States
(12) Patent Application Publication
(10) Pub. No.: US 2010/0125431 A1
(43) Pub. Date: May 20, 2010

(54) COMPACT TEST CIRCUIT AND INTEGRATED CIRCUIT HAVING THE SAME

(76) Inventor: Woo-Hyun SEO, Gyeonggi-do (KR)

Correspondence Address: IP & T Law Firm PLC, 7700 Little River Turnpike, Suite 207, Annandale, VA, 22003, US

(21) Appl. No.: 12/427,901

(22) Filed: Apr. 22, 2009

(30) Foreign Application Priority Data
Nov. 17, 2008 (KR) 10-2008-0113936

(51) Int. Cl. G06F 19/00

(52) U.S. Cl. 702/120

(57) ABSTRACT

A compact test circuit prevents a chip area increase by reducing the number of global lines, i.e., transmission paths of test mode item signals. The test circuit is capable of reducing a test time by performing several tests in parallel through one test mode item signal. The test circuit includes a test mode item signal generating block configured to generate a plurality of test mode item signals corresponding to test mode items, and a coding block configured to code each of the test mode item signals to generate a multiplicity of test control signals.

### CROSS-REFERENCE TO RELATED APPLICATIONS

The present invention claims priority of Korean patent application number 10-2008-0113936, filed on Nov. 17, 2008, which is incorporated by reference in its entirety.

### BACKGROUND OF THE INVENTION

The present invention relates to a semiconductor designing technique, and more particularly, to a test circuit for testing an internal circuit of an integrated circuit such as a semiconductor memory device.

In general, when semiconductor products are developed and mass-produced, various tests are used to verify required characteristics and functions of the products and confirm whether various functions required in a mounted state normally operate or not.

FIG. 1 is a block diagram illustrating a typical memory device having a test circuit.

As illustrated in FIG. 1, a test circuit 100 generates test mode item signals TEST1 to TESTn corresponding to various test mode items in response to a mode register set signal MRSP, a test related address ADDR, and a reset signal RESET. The mode register set signal MRSP is obtained by decoding an external command. The reset signal RESET is a signal for resetting a test mode. Here, n is a natural number equal to or greater than 2.

Also, the test mode item signals TEST1 to TESTn generated in the test circuit 100 are inputted into a corresponding internal circuit 140_1 to 140_{—}n through each global line GL.

However, one drawback is that the typical test circuit 100 has to increase the number of global lines GLs corresponding to the number of the test mode item signals TESET1 to TESTn when there are many test modes to be tested. That is, the test mode item signals TEST1 to TESTn generated in the typical test circuit 100 need to pass through the global lines GLs to be transferred to corresponding internal circuits. Therefore, when the test mode items increase, the number of the global lines GLs also increases according to the increased number of the test mode items. That is, there is a drawback in that a semiconductor memory chip area increases as the number of global lines GLs increases.

In addition, in the typical test circuit, when one test mode item signal is activated, internal circuits operate on a specific test mode. Here, the specific test mode may be one test mode selected from various test mode combinations.

As such, only one test mode corresponding to a test mode item signal is performed in the typical test circuit. That is, even if there are various test modes, only one test mode selected through one test mode item signal is performed. Accordingly, in order to perform various test modes, a test mode item signal needs to be continuously applied. Therefore, a test time is increased.

### SUMMARY OF THE INVENTION

An embodiment of the present invention is directed to providing a compact test circuit preventing a chip area increase by reducing the number of global lines (i.e., transmission paths of test mode item signals), and an integrated circuit having the same.

Another embodiment of the present invention is directed to providing a test circuit capable of reducing a test time by performing several tests in parallel through one test mode item signal, and an integrated circuit having the same.

In accordance with an aspect of the present invention, there is provided a test circuit, including a test mode item signal generating block configured to generate a plurality of test mode item signals corresponding to test mode items; and a coding block configured to code each of the test mode item signals to generate a multiplicity of test control signals.

In accordance with another aspect of the present invention, there is provided an integrated circuit, including a test mode item signal generating block configured to generate a test mode item signal corresponding to a test mode item; a coding block configured to code the test mode item signal to generate first and second test control signals; and first and second internal circuits configured to be test-driven concurrently in response to the corresponding first and second test signals and having no cross-circuit effect.

In accordance with another aspect of the present invention, there is provided an integrated circuit, including a test mode item signal generating block configured to generate a plurality of test mode item signals corresponding to test mode items in response to an input signal applied through a global line; a coding block configured to receive the plurality of test mode item signals through a first local line and code the plurality of test mode item signals to generate multiple test control signals per each of the test mode item signals; and a multiplicity of internal circuits configured to receive the multiplicity of test control signals through a second local line, and to be test-driven in response to the corresponding test control signal, wherein at least two internal circuits are configured to be test-driven concurrently.

In accordance with another aspect of the present invention, there is provided a method for testing an internal circuit of an integrated circuit, including: generating a test mode item signal corresponding to a test mode item; coding the test mode item signal to generate at least two test control signals; and test-driving at least two internal circuit blocks concurrently by using the test control signals.

### BRIEF DESCRIPTION OF THE DRAWINGS

FIG. 1 is a block diagram illustrating a typical memory device having a test circuit.

FIG. 2 is a block diagram of an integrated circuit according to one embodiment of the present invention.

FIG. 3 is a circuit diagram illustrating a test mode item signal generating block.

FIG. 4 is a timing diagram illustrating test mode item signals TEST1 to TEST4 which are sequentially activated by a test mode entry signal TMEN and a pulse signal PULSE.

FIGS. 5A and 5B illustrate embodiments of the coding block.

### DESCRIPTION OF SPECIFIC EMBODIMENTS

Other objects and advantages of the present invention can be understood by the following description, and become apparent with reference to the embodiments of the present invention.

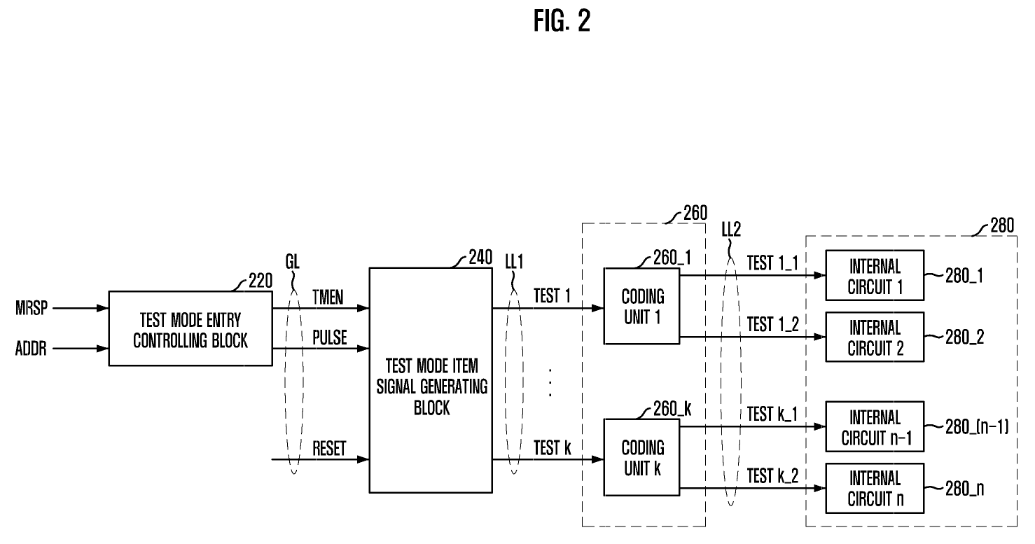

FIG. 2 is a block diagram of an integrated circuit according to one embodiment of the present invention.

As illustrated in FIG. 2, the integrated circuit according to the one embodiment of the present invention includes a test mode entry controlling block 220, a test mode item signal generating block 240, a coding block 260, and an internal circuit block 280.

The test mode entry controlling block 220 generates a test mode entry signal TMEN and a pulse signal PULSE based on a mode register set signal MRSP and an address signal ADDR. Here, the mode register set signal MRSP inputted into the test mode entry controlling block 220 is a signal obtained by decoding an external command by a mode register set (not shown).

The test mode entry controlling block 220 enables the test mode entry signal TMEN when an address related to the test mode entry is enabled among address signals ADDR in a state where the mode register set signal MRSP is enabled. Additionally, the pulse signal PULSE is toggled by a test related address among address signals ADDR.

The generated test mode entry signal TMEN and the pulse signal PULSE are transferred to the test mode item signal generating block 240 through global line GLs.

The test mode item signal generating block 240 receives the test mode entry signal TMEN, the pulse signal PULSE, and a reset signal RESET to generate a plurality of test mode item signals TEST1 to TESTk. The test mode item signals TEST1 to TESTk are sequentially activated at a predetermined time interval. Here, k is a natural number equal to or greater than 2.

The test mode item signal generating block 240 generates a plurality of test mode item signals TEST1 to TESTk based on signals transferred through the global line GLs. The test mode item signal generating block 240 transfers generated signals to the coding block 260 through the corresponding number of first local lines LL1.

The coding block 260 includes a plurality of coding units 260_1 to 260_{—}k each configured to code one test mode item signal to generate a plurality of test control signals per one test mode item signal. In FIG. 2, one test mode item signal is used to generate two test control signals. That is, the coding unit 260_1 receives the test mode item signal TEST1 to generate test control signals TEST1_1 and TEST1_2. Likewise, the coding unit 260_{—}k receives the test mode item signal TESTk to generate test control signal TESTk_1 and TESTk_2.

The test control signals TEST1_1 to TESTk_2 outputted from the coding block 260 are transferred to internal circuits through the corresponding number of second logic lines LL2.

The internal circuit block 280 includes a plurality of internal circuits 280_1 to 280_{—}n. Herein, n is a natural number equal to or greater than k. Herein, the number of the internal circuits 280_1 to 280_{—}n corresponds to the test control signals TEST1_1 to TESTk_2.

The test mode item signal generating block 240 and the coding block 260 are disposed adjacent to the internal circuit block 280. That is, the test mode item signals TEST1 to TESTk and the test signals TEST1_1 to TESTk_2 are transferred through the local lines LLs. The local lines LLs are formed with the shortest path.

The coding block 260 makes it possible to perform various tests in parallel simultaneously. For example, a setup hold time control circuit for analyzing defects, a bit line sensing margin control circuit, a column address margin control circuit, and a data access time (tAC) tuning circuit are internal circuits, and the circuits do not have effect on one another. Since these circuits allow tests to be performed in parallel simultaneously using one test mode item signal, a new test mode item signal does not need to be generated if the coding unit is used.

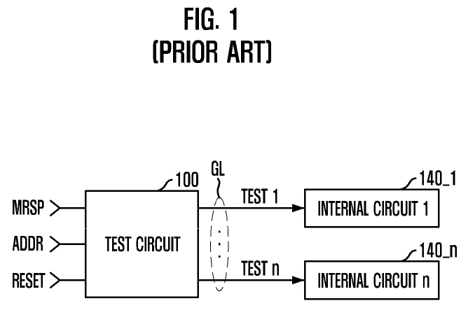

In the prior art arrangement shown in FIG. 1, each test mode item signal per a test mode item is generated and then provided to the internal circuit through the global lines whose number corresponds to that of the test mode item signals. However, in this embodiment, only three global lines are disposed to transfer a test mode entry signal TMEN, a pulse signal PULSE, and a reset signal RESET. The local lines LL1 and LL2 connecting the test mode item signal generating block 240 the internal circuit block 280 are disposed corresponding to the number of test mode items. Since lengths of local lines LL1 and LL2 are short, the area of signal lines for a test is reduced in comparison with the prior art. That is, a chip area can be reduced.

Moreover, since the coding block 260 is used, the number of the first local lines LL1 may be smaller than that of the second local lines LL2. In the embodiment of FIG. 2, the number of the first local line LL1 is only half the number of second local lines LL2.

Additionally, since the coding block is used, it is possible to test internal circuits having no cross-effect in parallel, a test time can be drastically reduced.

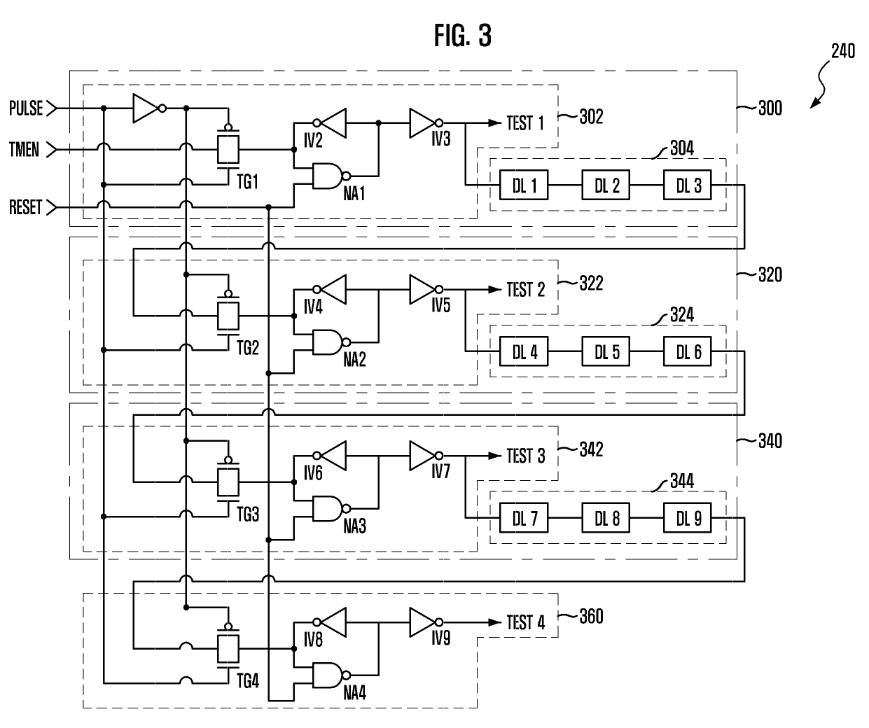

FIG. 3 is a circuit diagram illustrating the test mode item signal generating block 240.

In FIG. 3, the test mode item signal generating block 240 outputs four test mode item signals TEST1 to TEST4. The test mode item signal generating block 240, as illustrated in FIG. 3, includes four shift registers 300, 320, 340, and 360 connected in series.

The shift register 300 of a first stage includes a latch unit 302 and a delay unit 304. The latch unit 302 latches a test mode entry signal TMEN in response to a pulse signal PULSE, outputs the test mode item signal TEST1, and is reset by a reset signal RESET. The delay unit 304 delays the test mode item signal TEST1 by a predetermined time.

Here, the latch unit 302 includes an inverter IV1, a transmission gate TG1, a NAND gate NA1, an inverter IV2, and an inverter IV3. The inverter IV1 inverts a pulse signal PULSE, and the transmission gate TG1 transfers the test mode entry signal TMEN in response to the pulse signal PULSE. The NAND gate NA1 performs a NAND operation on a signal transferred from the transmission gate TG1 and the reset signal RESET, and the inverter IV2 inverts an output of the NAND gate NA1 and transfers inverted output as an input of the NAND gate NA1. The inverter IV3 inverts an output of the NAND gate NA1 and outputs inverted output as the test mode item signal TEST1. An output terminal of the inverter IV2 is connected to an output terminal of the transmission gate TG1.

Additionally, the delay unit 304 includes a plurality of delay elements DL1 to DL3 connected in series, which delay the test mode item signal TEST1 by a predetermined time. The delay unit 304 may have a predetermined delay amount to transfer an output at a point where the pulse signal PULSE is activated and operates the shifter register 320 of a second stage, or may have a delay amount smaller than the predetermined delay amount.

The shift register 320 of the second stage includes a latch unit 322 and a delay unit 324. The latch unit 322 latches an output of the delay unit 304 in response to the pulse signal PULSE, outputs a test mode item signal TEST2, and is reset by the reset signal RESET. The delay unit 324 delays the test mode item signal TEST2 by a predetermined time.

Here, the latch unit 322 includes a transmission gate TG2, a NAND gate NA2, an inverter IV4, and an inverter IV5. The transmission gate TG2 transfers the output of the delay unit 304 in response to the pulse signal PULSE. The NAND gate NA2 performs a NAND operation on a signal transferred from the transmission gate TG2 and the reset signal RESET. The inverter IV4 inverts an output of the NAND gate NA2 and transfers inverted output as an input of the NAND gate NA2. The inverter IV5 inverts the output of the NAND gate NA2 and outputs the test mode item signal TEST2. An output terminal of the inverter IV4 is connected to an output terminal of the transmission gate TG2.

Furthermore, the delay unit 324 includes a plurality of delay elements DL4 to DL6 connected in series, which delay the test mode item signal TEST2 by a predetermined time. The delay unit 324 may have a certain delay amount to transfer an output at a point where the pulse signal PULSE is activated and operates the shifter register 340 of a third stage, or may have a delay amount smaller than the certain delay amount.

The shifter register 340 of the third stage includes a latch unit 342 and a delay unit 344. The latch unit 342 latches an output of the delay unit 324 in response to the pulse signal PULSE to output it as a test mode item signal TEST3 and is reset by the reset signal RESET. The delay unit 344 delays the test mode item signal TEST3 by a predetermined time.

Here, the latch unit 342 includes a transmission gate TG3, a NAND gate NA3, an inverter IV6, and an inverter IV7. The transmission gate TG3 transfers an output of the delay unit 324 in response to the pulse signal PULSE. The NAND gate NA3 performs a NAND operation onto a signal transferred from the transmission gate TG3 and the reset signal RESET. The inverter IV6 inverts an output of the NAND gate NA3 and transfers inverted output as an input of the NAND gate NA3. The inverter IV7 inverts the output of the NAND gate NA3 and outputs the test mode item signal TEST3. Herein, an output terminal of the inverter IV6 is connected to an output terminal of the transmission gate TG3.

Moreover, the delay unit 344 includes a plurality of delay elements DL7 to DL9 connected in series, which delay the test mode item signal TEST3 by a predetermined time. At this point, the delay unit 344 may have a predetermined delay amount or a smaller delay amount, in order to transfer an output at a point where the pulse signal PULSE is enabled and operates the shifter register 360 of a fourth state.

The shifter register 360 of the fourth stage latches an output of the delay unit 344 in response to the pulse signal PULSE to output it as a test mode item signal TEST4 and is reset by the reset signal RESET.

Herein, the shifter register 360 includes a transmission gate TG4, a NAND gate NA4, an inverter IV8 and an inverter IV9. The transmission gate TG4 transfers the output of the delay unit 344 in response to the pulse signal PULSE. The NAND gate NA4 performs a NAND operation onto a signal transferred from the transmission gate TG4 and the reset signal RESET. The inverter IV8 inverts an output of the NAND gate NA4 and transfers inverted output as an input of the NAND gate NA4. The inverter IV9 inverts the output of the NAND gate NA4 and outputs the test mode item signal TEST4. At this point, an output terminal of the inverter IV8 is connected to an output terminal of the transmission gate TG4.

When examining an operation of the test mode item signal generating block 240 having the same structure as FIG. 3, if the pulse signal PULSE is enabled in a state where the test mode entry signal TMEN is enabled, the test mode item signal TEST1 is enabled and is transferred to a corresponding coding unit 260_1.

Also, the test mode item signal TEST1 maintains an enable state until the next enable point of the pulse signal PULSE, through the inverter IV2 and the NAND gate NA1 performing a latching operation.

In the next operation, test mode item signals TEST2 to TEST4 are sequentially enabled in synchronization with an enable point of the pulse signal PULSE, and then are transferred into a corresponding coding unit 260_2 to 260_{—}k.

Then, the plurality of shifter registers 300, 320, 340, and 360 constituting the test mode item signal generating block 240 are initialized by the reset signal RESET.

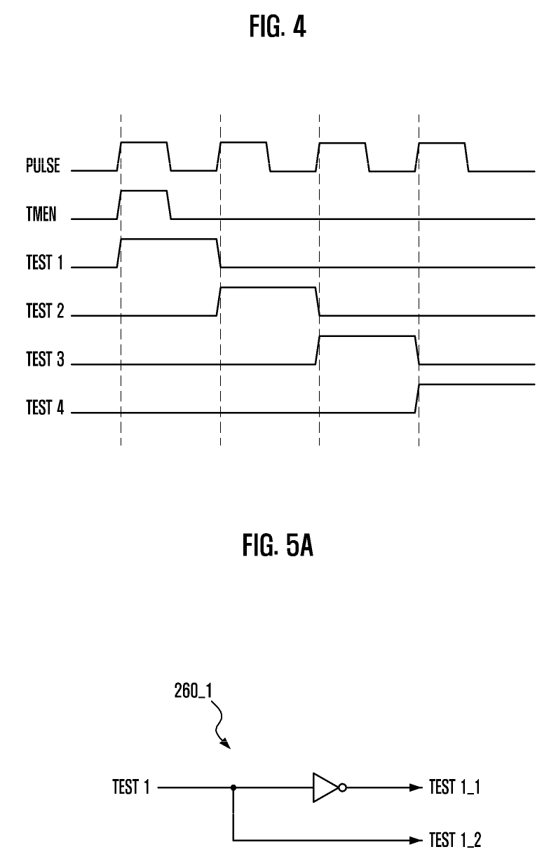

FIG. 4 is a timing diagram illustrating when test mode item signals TEST2 to TEST4 are sequentially activated by the test mode entry signal TMEN and the pulse signal PULSE.

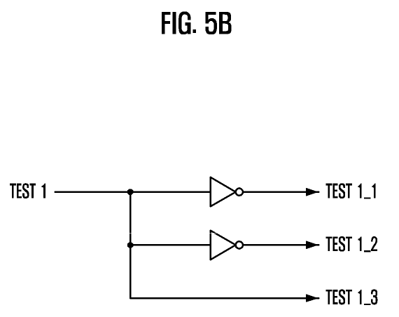

FIGS. 5A and 5B illustrate embodiments of the coding block 260. A coding unit 260_1 is illustrated as one coding unit among the plurality of coding units.

Referring to FIG. 5A, the coding unit 260_1 includes a first path and a second path. The first path bypasses the test mode item signal TEST1 to generate a test signal TEST1_2 and the second path inverts the test mode item signal TEST1 to generate a test signal TEST1_1.

FIG. 5B illustrates a coding unit generating three test signals TEST1_1 to TEST1_3 through one test mode item signal, and there are a bypass path and an inversion path also.

According to the present invention, only a test mode entry signal, a pulse signal, and a reset signal are transferred to a test mode item signal generating block through global lines GLs. After the test mode item signal generating block generates several item signals, each item signal is transferred to a corresponding internal circuit through a local input line or output line. As a result, the number of global lines is reduced and thus an area for a semiconductor memory chip can be decreased.

Additionally, since several tests are simultaneously performed in parallel through one test mode item signal in a coding unit, a test time can be reduced.

While the present invention has been described with respect to the specific embodiments, it will be apparent to those skilled in the art that various changes and modifications may be made without departing from the spirit and scope of the invention as defined in the following claims.

What is claimed is:

1. A test circuit, comprising:
a test mode item signal generating block configured to generate a plurality of test mode item signals corresponding to test mode items; and
a coding block configured to code each of the test mode item signals to generate a multiplicity of test control signals.

2. The test circuit of claim 1, wherein the test mode item signal generating block activates the plurality of test mode item signals sequentially.

3. The test circuit of claim 1, wherein the coding block includes a plurality of coding units, each including:
a first path configured to pass the test mode item signal to be outputted as a first test control signal; and
a second path configured to invert the test mode item signal to generate a second test control signal.

4. The test circuit of claim 1, further comprising:
a test mode entry controlling block configured to generate a test mode entry signal to provide the test mode entry signal to the test mode item signal generating block.

5. The test circuit of claim 4, wherein the test mode entry controlling block is configured to generate a pulse signal toggled based on a test address and output the pulse signal to the test mode item signal generating block.

6. The test circuit of claim 5, wherein the test mode item signal generating block is configured to sequentially latch the test mode entry signal by a predetermined time interval in response to the pulse signal in order to output the test mode item signals.

7. The test circuit of claim 5, wherein the test mode item signal generating block includes:
a plurality of shift registers connected in series, the shift registers being configured to output the test mode item signals sequentially,
wherein the shift register of a first stage is configured to latch the test mode entry signal in response to the pulse signal, and the shift registers of the next stage are configured to latch an output of the shift register of the previous stage in response to the pulse signal.

8. The test circuit of claim 1, wherein the test mode item signal generating block is configured to be reset by a reset signal.

9. The test circuit of claim 5, wherein the test mode entry signal and the pulse signal are configured to be transferred to the test mode item signal generating block through a global line.

10. The test circuit of claim 1, wherein the test mode item signal and the test control signal are configured to be transferred through a local line.

11. An integrated circuit, comprising:
a test mode item signal generating block configured to generate a test mode item signal corresponding to a test mode item;
a coding block configured to code the test mode item signal to generate first and second test control signals; and
first and second internal circuits configured to be test-driven concurrently in response to the corresponding first and second test signals and having no cross-circuit effect.

12. The integrated circuit of claim 11, wherein the test mode item signal generating block is configured to generate a plurality of the test mode item signals that are sequentially activated corresponding to a plurality of the test mode items.

13. The integrated circuit of claim 11, wherein the coding block includes:
a first path configured to pass the test mode item signal to be outputted as the first test control signal; and
a second path configured to invert the test mode item signal to generate the second test control signal.

14. The integrated circuit of claim 11, further comprising:
a test mode entry controlling block configured to generate a test mode entry signal to provide the test mode entry signal to the test mode item signal generating block.

15. The integrated circuit of claim 14, wherein the test mode entry controlling block is configured to generate a pulse signal toggled based on a test address in order to output the pulse signal to the test mode item signal generating block.

16. The integrated circuit of claim 15, wherein the test mode item signal generating block is configured to sequentially latch the test mode entry signal by a predetermined time interval in response to the pulse signal to output a plurality of the test mode item signals.

17. The integrated circuit of claim 16, wherein the test mode item signal generating block includes:
a plurality of shift registers connected in series, the shift registers being configured to output the test mode item signals sequentially,
wherein the shift register of a first stage is configured to latch the test mode entry signal in response to the pulse signal, and the shift registers of the next stage are configured to latch an output of the shift register of the previous stage in response to the pulse signal.

18. The integrated circuit of claim 11, wherein the test mode item signal generating block is configured to be reset by a reset signal.

19. The integrated circuit of claim 11, wherein the test mode item signal generating block and the coding block are disposed adjacent to the first and second internal circuits.

20. The integrated circuit of claim 15, wherein the test mode item signal generating block is configured to receive the test mode entry signal and the pulse signal through a global line.

21. An integrated circuit, comprising:
a test mode item signal generating block configured to generate a plurality of test mode item signals corresponding to test mode items in response to an input signal applied through a global line;
a coding block configured to receive the plurality of test mode item signals through a first local line and code the plurality of test mode item signals to generate multiple test control signals per each of the test mode item signals; and
a multiplicity of internal circuits configured to receive the multiplicity of test control signals through a second local line, and to be test-driven in response to the corresponding test control signal, wherein at least two internal circuits are configured to be test-driven concurrently.

22. The integrated circuit of claim 21, wherein the test mode item signal generating block is configured to generate the plurality of test mode item signals that are sequentially activated.

23. The integrated circuit of claim 22, wherein the coding block includes a plurality of coding units, each coding unit including:
a first path configured to pass the test mode item signal to be outputted as a first test control signal; and
a second path configured to invert the test mode item signal to generate a second test control signal.

24. The integrated circuit of claim 21, further comprising:
a test mode entry controlling block configured to generate a test mode entry signal as the input signal of the test mode item signal generating block.

25. The integrated circuit of claim 24, wherein the test mode entry controlling block is configured to generate a pulse signal as the input signal, the pulse signal being toggled based on a test address.

26. The integrated circuit of claim 25, wherein the test mode item signal generating block is configured to sequentially latch the test mode entry signal by a predetermined time interval in response to the pulse signal to output the test mode item signals.

27. The test circuit of claim 25, wherein the test mode item signal generating block includes:
a plurality of shift registers connected in series, the shift registers are configured to output the test mode item signals sequentially,
wherein the shift register of a first stage is configured to latch the test mode entry signal in response to the pulse signal, and the shift registers of the next stage are configured to latch an output of the shift register of the previous stage in response to the pulse signal.

28. The test circuit of claim 21, wherein the test mode item signal generating block is configured to be reset by a reset signal.

29. The integrated circuit of claim 21, wherein the test mode item signal generating block and the coding block are disposed adjacent to the internal circuit.

30. The integrated circuit of claim 21, wherein the first local line is provided in at least half the number of the second local lines.

31. A method for testing an internal circuit of an integrated circuit, the method comprising:
generating a test mode item signal corresponding to a test mode item;
coding the test mode item signal to generate at least two test control signals; and
test-driving at least two internal circuit blocks concurrently by using the test control signals.

32. The method of claim 31, further comprising:
generating a plurality of the test mode item signals that are sequentially activated corresponding to a plurality of the test mode items during generating the test mode item signal.

33. The method of claim 32, wherein coding the test mode item signal includes:
passing the test mode item signal to be outputted as a first test control signal; and
inverting the test mode item signal to generate a second test control signal.

34. The method of claim 31, wherein generating the test mode item signal includes:
generating a first test mode item signal by latching a test mode entry signal in response to a pulse signal toggled according to a test address;
delaying the first test mode item signal; and
generating a second test mode item signal by latching the delayed first test mode item signal in response to the pulse signal.
